(19) United States
(12) Patent Application Publication
(10) Pub. No.: US 2026/0338678 A1
(43) Pub. Date: Oct. 29, 2026

(54) SELF-CALIBRATING NON-DISPERSIVE INFRARED DETECTION APPARATUS

(71) Applicant: Taiwan Nano & Micro-Photonics Co., Ltd., Taipei City (TW)

(72) Inventors: Yi-Chan Teng, Taipei City (TW); Ching-Fuh Lin, Taipei (TW); Kun-Yu Chang, Taipei City (TW)

(21) Appl. No.: 19/322,489

(22) Filed: Sep. 8, 2025

Related U.S. Application Data
(60) Provisional application No. 63/796,413, filed on Apr. 29, 2025.

(51) Int. Cl. G01N 21/3504; G01N 21/25; G01N 21/31

(52) U.S. Cl. CPC G01N 21/3504; G01N 21/255; G01N 21/314

(57) ABSTRACT

Employing non-dispersive infrared (NDIR) principles, the provided detection apparatus achieves self-calibration through a dual-channel optical cell. A light source emits an infrared radiation with a specific wavelength to illuminate both channels. One channel serves as a stable reference, which is hermetically sealed and is entirely devoid of matter or contains a reference medium that does not absorb the infrared radiation at the specific wavelength. The other channel allows the fluid sample to be detected to enter. Continuous, real-time self-calibration is enabled by comparing the signal intensities from the two channels. This comparative analysis effectively mitigates the impact of environmental fluctuations and component drift, significantly enhancing the accuracy and long-term reliability of component concentration measurements for various applications.

### CROSS-REFERENCE TO RELATED APPLICATIONS

This application claims the benefit under 35 U.S.C. 119(e) of U.S. Provisional Patent Application No. 63/796,413 filed on Apr. 29, 2025. This application and all published documents discussed below are expressly incorporated by reference herein, in their entirety.

### BACKGROUND OF THE INVENTION

### 1. Field of the Invention

The present invention relates to a self-calibrating non-dispersive infrared (NDIR) detection apparatus for detecting a target component in a fluid sample.

### 2. Description of Related Art

Non-Dispersive Infrared (NDIR) detection is widely used to detect gases that absorb specific wavelengths of infrared radiation. Conventional NDIR sensors often suffer from drift caused by unstable light source intensity and variable detector sensitivity, and therefore require regular calibration to maintain accuracy. These calibration procedures typically involve exposing the sensor to a known gas concentration, which can be time-consuming, expensive, and impractical for continuous monitoring applications.

Environmental factors such as temperature and humidity fluctuations, changes in air pressure, and aging of components such as light sources and sensors can significantly affect measurement accuracy. In addition, it is difficult for existing single-channel NDIR sensors to effectively distinguish between signal attenuation caused by changes in target gas concentration and signal changes caused by fluctuations in the system's own performance (e.g., changes in light source output, detector sensitivity drift). Some methods, e.g., EP3179233A1, use a certain wavelength not absorbed by a target gas to be measured as a reference to correct the intensity of the light source, in which the non-absorbed wavelength and the absorption wavelength of the target gas are emitted from a same light source. This approach requires special filtering, to switch a first bandpass filter or a second bandpass filter on the optical path. If the filter characteristics change, it will cause a correction error. In addition, the correction may be inaccurate due to the change in the ratio of light intensity of non-absorbed wavelength to the absorption wavelength.

In addition, U.S. Pat. No. 8,003,944B2 discloses an apparatus, which includes: a signal channel with a signal detector; a reference channel with a reference detector and a saturation cell containing the gas of interest; and a single narrow band-pass spectral filter used for both the signal channel and the a reference channel; wherein both the signal detector and the reference detector are mounted on a single thermal platform. The reference channel signal remains substantially unchanged irrespective of the absence or presence of the gas to be detected in any concentration level in a sample chamber of the non-dispersive infrared sensor. The saturation cell has a length L′ and contains a concentration c′ of the gas of interest such that a resulting saturation cell concentration of the gas of interest of (L′)×(c′) is at least an order of magnitude greater than a sample cell concentration of the gas of interest of (L)×(c), where L is a length of a sample cell of the signal channel and c is a maximum concentration of the gas of interest in the sample cell.

US08143581B2 discloses an NDIR gas sensor and methodology using an absorption bias between signal and reference outputs to determine sample concentration of a gas being measured. The absorption bias is created by using a signal channel in a sample chamber with a signal path length that is greater than a reference path length of a reference channel in the sample chamber while both the signal and reference detectors have an identical narrow band pass filter with the same Center Wavelength (“CWL”), Full Width Half Maximum (FWHM) and transmittance efficiency at the CWL. Performance is improved when the reference detector and the signal detector share a common thermal platform that can also be shared by the sample chamber and the infrared source. And US08178832B1 discloses a re-calibration method for a dual-beam NDIR gas sensor disclosed in US08143581B2.

Although the conventional methodology uses two identical narrow band pass filters in the reference channel and the signal channel, there may be differences between the individual band pass filters and between the reference detector and the signal detector. In addition, the gas sensor is limited to detect the same target gas as in the saturation cell. Therefore, an improved NDIR detection apparatus is required to maintain measurement accuracy during operation.

### SUMMARY OF THE INVENTION

This summary is provided to introduce a selection of concepts in a simplified form that are further described below in the detailed description. This summary, and the foregoing background, is not intended to identify key aspects or essential aspects of the claimed subject matter. Moreover, this summary is not intended for use as an aid in determining the scope of the claimed subject matter.

The present invention discloses a self-calibrating non-dispersive infrared (NDIR) detection apparatus with a true zero reference. The NDIR detection apparatus utilizes a wavelength-specific infrared light source and photodetector optimized for target component detection. Its unique dual-channel design consists of a hermetically sealed reference channel (vacuumed or containing an inert nitrogen) and a measurement channel (allowing a fluid sample to flow through). By continuously comparing the signals from the reference and measurement channels, the system enables real-time self-calibration, which eliminates the need for manual calibration, and automatically compensates for environmental factors and component aging, thereby significantly improving measurement accuracy and reliability.

Key features of this invention include:
Mid- and long-wave infrared light source: An infrared light source that emits an infrared radiation with a specific wavelength that is within a mid-and long-wave region (wavelength range of about 2 μm to about 14 μm) and matches a specific absorption band of a target component molecule to be measured. For example, an infrared emitter that emits a narrowband infrared light with a (center) wavelength of 4.26 μm, which corresponds to a strong absorption band of carbon dioxide molecules. The narrowband infrared (IR) emitter improves the sensitivity of CO₂ detection. In addition, the infrared light source could be an infrared thermal emitter that is wavelength-tunable to emit the infrared radiation with one or more specific wavelengths corresponding to one or more absorption bands of one or more target components, so that one or more target components in a fluid sample can be detected in the meantime.
Reference Channel: A hermetically sealed optical path that is vacuumed or filled with an inert gas (e.g., nitrogen N₂) that does not absorb the infrared radiation at the specific wavelength. This hermetically sealed design ensures that the reference channel signal is independent of the target component concentration, thereby providing a stable reference.
Measurement Channel: An optical path through which the fluid sample to be analyzed flows, typically including an inlet and an outlet to ensure that the fluid sample adequately interacts with the infrared beam. The target component molecules in the measurement channel absorb infrared radiation at specific wavelength(s), resulting in a decrease in the intensity of the transmitted light.

Detector: At least a detector with high sensitivity to the specific wavelength absorbed by the target component is selected to receive the infrared light passing through the reference channel and the measurement channel, respectively.
Optical Cell Design: Cylindrical or other appropriately shaped optical cells plated with gold or other highly reflective materials effectively guide the infrared radiation through the two channels by multiple reflections. This design increases the optical path in the measurement channel, improving the sensitivity of target component absorption while minimizing the loss of optical signal. In contrast, the reference channel does not require an additional optical path, the optical path of which can be very short. The reference channel can have a relatively short length and a relatively small cross-sectional area.
Signal Processing Circuit: Includes electronic circuits and associated algorithms to receive and process reference and measurement signals from detectors. The circuit analyzes the difference between the two signals and calculates the concentration of the target component according to the Beer-Lambert law, while using the change in the reference signal to compensate for system drift and the influence of environmental factors to achieve accurate target component concentration measurements.
Calibration Unit: Includes a microcontroller unit (MCU) and a memory. When the detection apparatus starts to operate at the factory, an initial infrared radiation intensity of the reference channel and the measurement channel at the specific wavelength is recorded before a fluid sample (e.g., a gas sample) is introduced. This recorded value is used as a baseline for later comparison. Subsequently, it is only necessary to measure the infrared radiation intensity of the reference channel and compare it with the initial infrared radiation intensity of the reference channel recorded at the factory (i.e., at the time start of use). Then, the incident infrared radiation intensity of the measurement channel at the time of measurement can be calculated, which is then used to calculate the concentration of the target component.

The working principle of the present invention is based on Beer-Lambert's law, which describes the relationship between the attenuation of light intensity and the absorption characteristics of the medium when light propagates in a medium: I=I₀*e^(−acL). This law shows that there is an exponential relationship between the intensity of transmitted light (I) and the intensity of incident light (I₀), the absorption coefficient of the target component (a), the concentration of the target component (c), and the optical path (L).

If the incident light intensity I₀ is varied due to systematic factors (e.g., aging or fluctuations of the light source) and is not compensated or corrected, estimating the concentration of target component solely based on the measured transmitted infrared radiation intensity I will be incorrect. The dual-channel design of the present invention is specifically designed to overcome this problem. Changes in incident light intensity are reflected in real time by additionally monitoring the change in light intensity of the reference channel.

The core of the present invention is the use of a reference channel to monitor an overall change of the system (including changes in the intensity of the infrared radiation) in real time, which is used as a correction factor applied to the signal analysis of the measurement channel. This approach eliminates the influence of system drift on the measurement of target component concentration, thereby achieving self-calibration.

The specific mid-and long-wave infrared radiation emitted by an infrared light source (e.g., a 4.26-μm light source) is directed to a dual-channel optical cell.

Mid-and long-wave infrared radiation passes through a reference channel (filled with vacuum or N₂) and a measurement channel (e.g., containing the CO₂ gas to be measured or two or more target components to be measured).

Since the vacuum absorbs negligible or no target component to be measured, the intensity of the infrared light received by the reference channel ideally remains relatively constant. Any changes in the reference channel signal mainly reflect fluctuations in the system (e.g., light source intensity drift, temperature effects, etc.).

The molecules in the measurement channel absorb a portion of the infrared radiation, resulting in a decrease in the intensity of light received by the measurement channel. This decrease is positively correlated with the concentration of the target component to be measured.

The detector receives the infrared light signal from each of the two channels, and the signal processing circuit then calculates the ratio or difference of the two signals and calculates the gas concentration to be measured based on Beer-Lambert's law. Importantly, during the calculation, the signal processing circuit corrects the signal of the measurement channel using the signal change of the reference channel, thus automatically compensating for changes in the system.

Through this continuous comparison and real-time correction, the present invention can achieve real-time self-calibration without interrupting the measurement process, ensuring the accuracy and reliability of target component concentration measurement.

### Technical Advantages

True Zero Point: detected signal change from the inventive refence channel provides a physically based true zero baseline, representing the original intensity of the incident light, I₀. Concentration calculations from a true zero point are more algorithmically straightforward and less susceptible to nonlinear effects.

Continuous self-calibration: Because the reference channel provides a stable baseline signal that is not affected by the target component, the signal processing circuit can monitor and compensate for system drift in real time, enabling continuous self-calibration without the need for periodic external calibration.

Higher accuracy: The present invention significantly improves the accuracy and stability of target component concentration measurement by compensating for signal changes caused by temperature fluctuations, and the aging of components such as light sources and detectors in real time. Even if the intensity of the light source changes, the reference channel will reflect this change synchronously, allowing the measured signal calibrated based on the reference signal to more accurately reflect the concentration of the component of interest.

Reduced cost and maintenance: Achieving an industrial-grade vacuum or filling with low-cost inert gas, e.g., nitrogen, is far simpler and more cost-effective than precisely processing and hermetically sealing a 100% pure target gas. Continuous self-calibration significantly reduces the need for frequent manual calibration procedures, reducing maintenance effort and associated costs for users.

Extended service life: Because performance degradation caused by the aging of components is automatically compensated, the present invention helps to extend the effective service life of the NDIR detection apparatus.

Higher reliability: The vacuumed reference channel does not degrade, and inert gases are chemically extremely stable. Conversely, a sealed target gas may degrade or react with the chamber walls over several years, introducing new sources of drift in the reference signal. This directly contradicts the problem it is intended to solve. The dual-channel design not only provides self-calibration but also provides some redundancy. By comparing the signals of the two channels, faults or anomalies in the system can be detected earlier, thus improving the overall reliability.

Versatility: The design principle of the present invention has a high degree of flexibility, and it can be applied to detect a variety of different target components by selecting a specific wavelength light source and a corresponding detector that match the absorption band of different target components.

Additional features of the invention are set out in the appended set of claims.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1A is a schematic diagram showing an NDIR (Non-Dispersive Infrared) detection apparatus according to an embodiment of the present invention.

FIG. 1B is a schematic diagram showing an NDIR detection apparatus according to another embodiment of the present invention.

FIG. 1C is a schematic diagram showing an NDIR detection apparatus according to another embodiment of the present invention.

FIG. 1D is a schematic diagram showing an NDIR detection apparatus according to another embodiment of the present invention.

FIG. 1E is a schematic diagram showing an NDIR detection apparatus according to another embodiment of the present invention.

FIG. 1F is a schematic diagram showing an NDIR detection apparatus according to another embodiment of the present invention.

FIG. 1G is a schematic diagram showing an NDIR detection apparatus according to another embodiment of the present invention.

FIG. 1H is a schematic diagram showing an NDIR detection apparatus according to another embodiment of the present invention.

FIG. 1I is a schematic diagram showing an NDIR detection apparatus according to another embodiment of the present invention.

FIG. 2 is a block diagram of the NDIR detection apparatus depicted in FIG. 1G according to an embodiment of the present invention.

FIG. 3 is a front view showing an NDIR detection apparatus according to an embodiment of the present invention.

### DETAILED DESCRIPTION OF THE PREFERRED EMBODIMENT

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

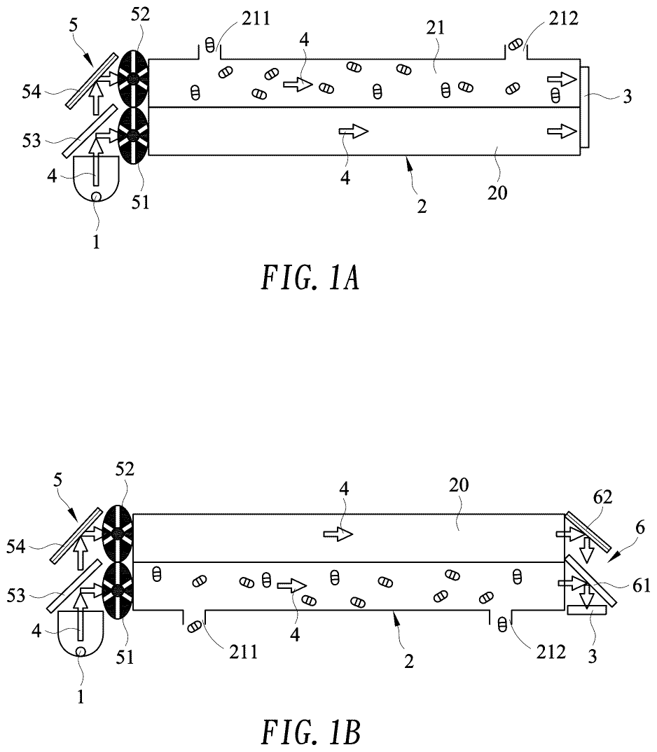

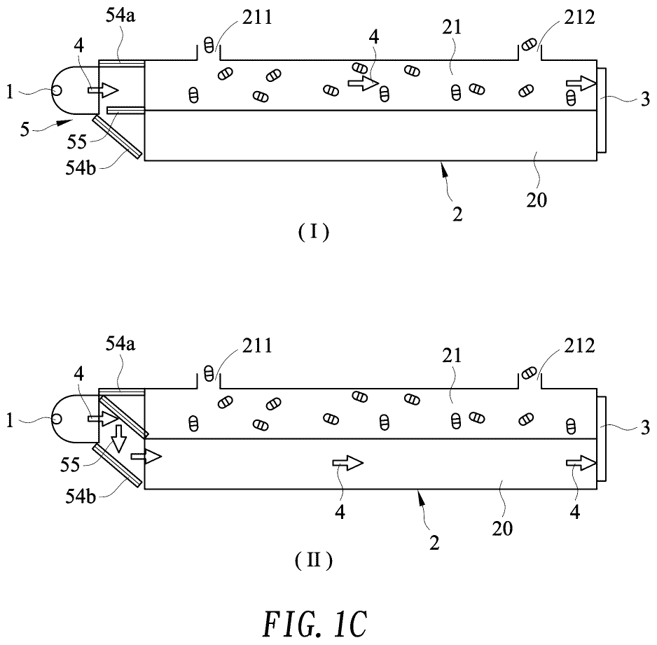

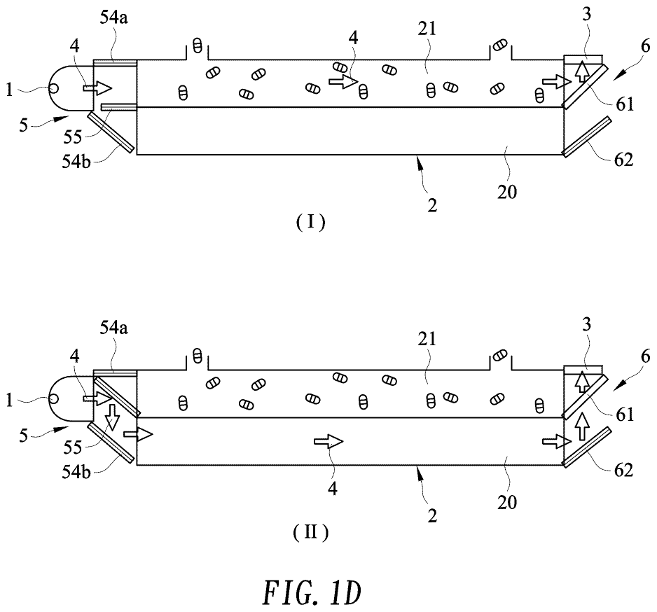

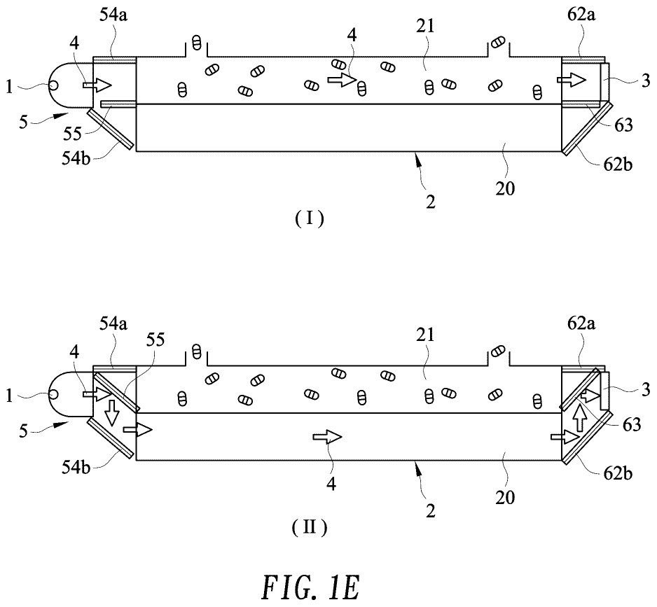

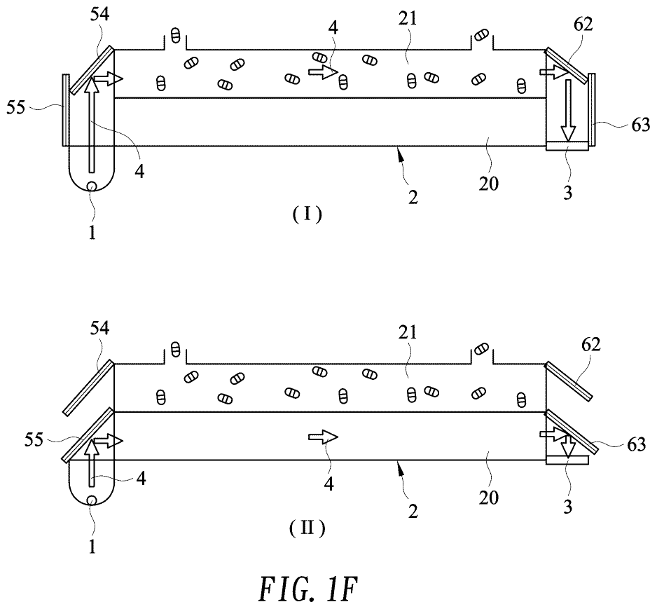

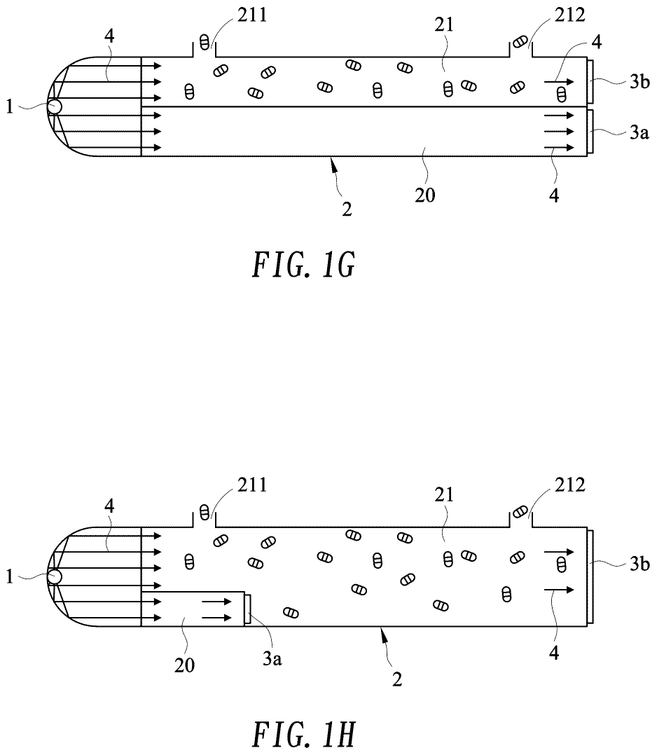

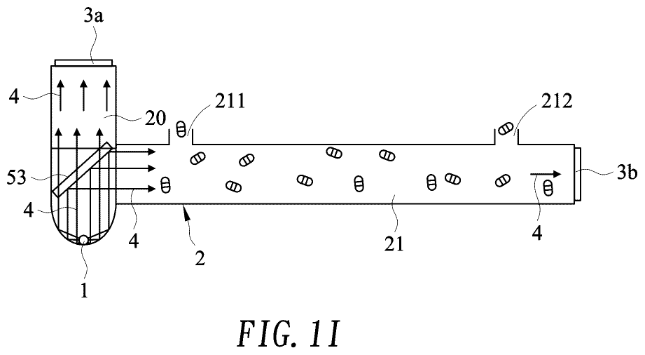

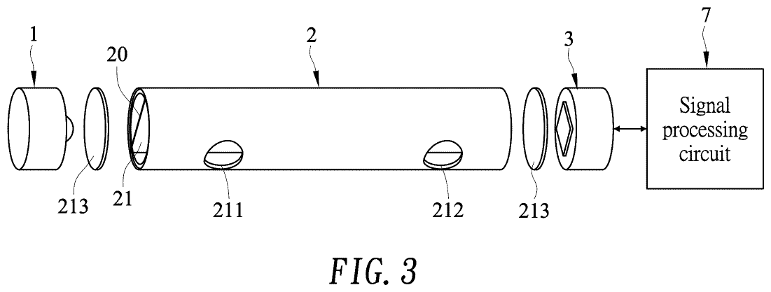

FIG. 1A is a schematic diagram showing an NDIR (Non-Dispersive Infrared) detection apparatus according to an embodiment of the present invention. The NDIR detection apparatus is used to determine the concentration of a target component (e.g., a target gas or a target substance) in a fluid sample (e.g., a gas sample or a liquid sample). In the illustrated embodiment, the target component is CO₂. Referring to FIG. 1A, in one embodiment, the NDIR detection apparatus includes an infrared light source 1, an optical cell 2, a detector 3, and a signal processing circuit 7 (FIG. 3). The infrared light source 1 emits an infrared radiation 4 with a specific wavelength corresponding to an absorption band of the target component. The absorption band refers to a specific wavelength or a range of wavelengths where the target component absorbs a significant amount of the emitted infrared radiation. In the illustrated embodiment, the specific wavelength is in a mid-and long-wavelength infrared region (spans wavelengths from about 2 μm to about 14 μm).

Referring to FIG. 1A, the infrared light source 1 is preferably a narrow band infrared emitter, e.g., a narrow band infrared thermal emitter disclosed in U.S. Patent Application Publication No. 20240420945A1 and U.S. Pat. No. 12,106,957B2, or a narrow band multi-wavelength thermal emitter disclosed in U.S. Provisional Patent Application No. 63/791,736 filed on Apr. 21, 2025. These patent applications are commonly assigned to the assignee of the present invention, and the entire contents of which are incorporated by reference as if fully set forth herein. In one embodiment, the infrared light source 1 emits an infrared light with a peak wavelength of 4.26 μm and a full width at half maximum (FWHM) about 0.15 μm. In one embodiment, the infrared light source 1 is an infrared emitter that is wavelength-tunable to emit the infrared radiation with one or more specific wavelengths corresponding to one or more absorption bands of one or more target components, and the one or more specific wavelengths are within the mid-and long-wavelength infrared region. For example, the emitting wavelength can be tuned by changing the current applied to the positive electrode and the negative electrode of the infrared thermal emitter disclosed in U.S. Patent Application Publication No. 20240420945A1 and U.S. Pat. No. 12,106,957B2.

Referring to FIG. 1A, the optical cell 2 includes a reference channel 20 and a measurement channel 21. The infrared light source 1 radiates the infrared radiation 4 into the reference channel 20 and the measurement channel 21. The reference channel 20 is hermetically sealed and is vacuumed or contains a reference medium that does not absorb the infrared radiation 4 at the specific wavelength. In one embodiment the reference channel 20 is hermetically sealed and is sufficiently vacuumed such that an amount of the infrared radiation 4 absorbed at the specific wavelength by medium (e.g., air) enclosed in the reference channel 20 is ignored. The reference channel 20 is preferably with a gaseous pressure less than 0.1 atmospheric pressure. In one embodiment, the reference medium is an inert gas, e.g., nitrogen. The pressure in the reference channel 20 may be controlled to be approximately 1 atmosphere if the reference channel 20 contains the reference medium that does not absorb the infrared radiation 4 at the specific wavelength. The measurement channel 21 is configured to flow the fluid sample and generally includes an inlet 211 for allowing the fluid sample to enter and an outlet 212 for allowing the fluid sample to flow out.

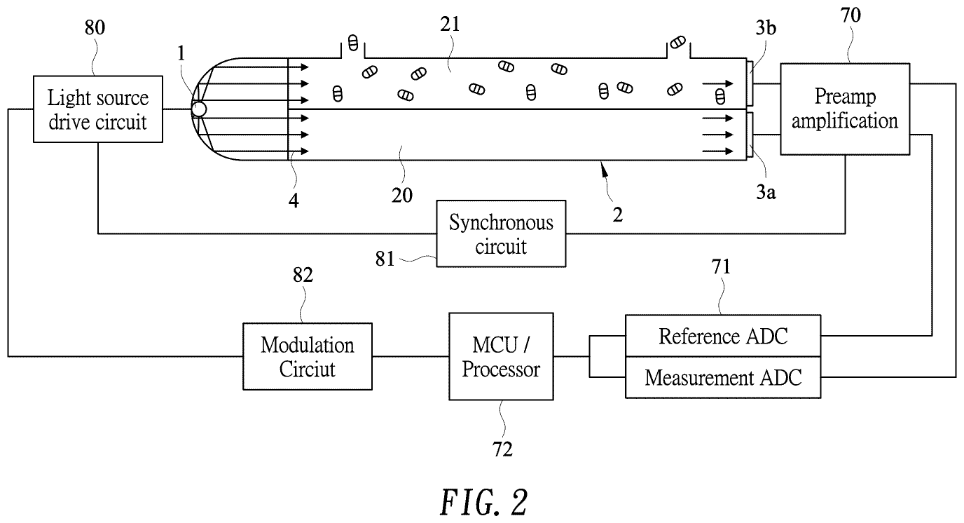

Referring to FIG. 1A, the detector 3 converts the infrared radiation 4 that has transmitted through the reference channel 20 into a reference signal and converts the infrared radiation 4 that has transmitted through the measurement channel 21 into a measurement signal. In one embodiment, the detector 3 is a photodetector disclosed in U.S. patent application Ser. No. 19/263,487 filed on Jul. 9, 2025. The signal processing circuit 7 (FIG. 3) includes a processor 72 (FIG. 2) that calculates a concentration of the target component based on a comparative analysis of the reference signal and the measurement signal.

Referring to FIG. 1A, the NDIR detection apparatus may include a front guiding unit 5 arranged between the infrared light source 1 and the optical cell 2 and configured to modulate the frequencies of the reference signal and the measurement signal, so that the reference signal and the measurement signal are distinguishable in the detector 3.

Referring to FIG. 1A, the front guiding unit 5 includes: a first chopper 51 between the infrared light source 1 and the reference channel 20 to periodically interrupt the infrared radiation 4 at a first chopping interval (the time between consecutive interruptions of the infrared radiation 4); and a second chopper 52 between the infrared light source 1 and the measurement channel 21 to periodically interrupt the infrared radiation 4 at a second chopping interval. In which the first chopping interval differs from the second chopping interval. The first chopper 51 modulates the infrared radiation 4 to convert it into a pulsed light with a first frequency. The second chopper 52 modulates the infrared radiation 4 to convert it into a pulsed light with a second frequency. In addition, the front guiding unit 5 may include a front spectroscope 53 and a front reflecting mirror 54 to direct the infrared radiation 4 into reference channel 20 and the measurement channel 21.

FIG. 1B is a schematic diagram showing an NDIR detection apparatus according to another embodiment of the present invention. The NDIR detection apparatus described in FIG. 1B is similar to the NDIR detection apparatus described in FIG. 1A, except as described below. Referring to FIG. 1B, the NDIR detection apparatus further includes a rear guiding unit 6 disposed between the optical cell 2 and the detector 3 and configured to guide the infrared radiation 4 to the detector 3.

FIG. 1C is a schematic diagram showing an NDIR detection apparatus according to another embodiment of the present invention. The NDIR detection apparatus described in FIG. 1C is similar to the NDIR detection apparatus described in FIG. 1A, except as described below. Referring to FIG. 1C, the front guiding unit 5 includes a rotatable front handoff mirror 55 and at least a front reflecting mirror, e.g., a first front reflecting mirror 54a and a second front reflecting mirror 54b, to sequentially direct the infrared radiation 4 into the reference channel 20 and the measurement channel 21, so that the reference signal and the measurement signal are separable in the detector 3. Referring to FIG. 1C, at time (I), the front handoff mirror 55 is controlled to be parallel to the first front reflecting mirror 54a, and the infrared radiation 4 is directed into the measurement channel 21. At time (II), the front handoff mirror 55 is controlled to be parallel to the second front reflecting mirror 54b, and the infrared radiation 4 is directed into the reference channel 20.

FIG. 1D is a schematic diagram showing an NDIR detection apparatus according to another embodiment of the present invention. The NDIR detection apparatus described in FIG. 1D is similar to the NDIR detection apparatus described in FIG. 1C, except as described below. Referring to FIG. 1D, the NDIR detection apparatus further includes a rear guiding unit 6 disposed between the optical cell 2 and the detector 3 and configured to guide the infrared light 4 to the detector 3. The rear guiding unit 6 may include a rear spectroscope 61 and a rear reflecting mirror 62 to direct the infrared radiation 4 into the detector 3.

FIG. 1E is a schematic diagrams showing an NDIR detection apparatus according to another embodiment of the present invention. The NDIR detection apparatuses described in FIG. 1E and is similar to the NDIR detection apparatus described in FIG. 1D, except as described below. Referring to FIG. 1E, the NDIR detection apparatus further includes a rear guiding unit 6 disposed between the optical cell 2 and the detector 3 and configured to guide the infrared light 4 to the detector 3. The rear guiding unit 6 may include a rotatable rear handoff mirror 63 and at least a rear reflecting mirror, e.g., a first rear reflecting mirror 62a and a second rear reflecting mirror 62b, to direct the infrared radiation 4 into the detector 3. At time (I), the front handoff mirror 55 is controlled to be parallel to the first front reflecting mirror 54a, and the rear handoff mirror 63 is controlled to be parallel to the first rear reflecting mirror 62a, such that the infrared radiation 4 is directed into the measurement channel 21 and then directed into the detector 3. At time (II), the front handoff mirror 55 is controlled to be parallel to the second front reflecting mirror 54b, and the rear handoff mirror 63 is controlled to be parallel to the second rear reflecting mirror 62b, such that the infrared radiation 4 is directed into the reference channel 20 and then directed into the detector 3.

FIG. 1F is a schematic diagram showing an NDIR detection apparatus according to another embodiment of the present invention. The NDIR detection apparatuses described in FIG. 1F is similar to the NDIR detection apparatus described in FIG. 1D, except as described below. Referring to FIG. 1F, the front guiding unit 5 includes a rotatable front handoff mirror 55 and a front reflecting mirror 54. In addition, the NDIR detection apparatus further includes a rear guiding unit 6 disposed between the optical cell 2 and the detector 3 and configured to guide the infrared light 4 to the detector 3. The rear guiding unit 6 may include a rotatable rear handoff mirror 63 and a rear reflecting mirror 62 to direct the infrared radiation 4 into the detector 3. At time (I), the front handoff mirror 55 and the rear handoff mirror 63 are controlled out of the optical path, such that the infrared radiation 4 is directed into the measurement channel 21 and then directed into the detector 3 by the front reflecting mirror 54 and the rear reflecting mirror 62. At time (II), the front handoff mirror 55 and the rear handoff mirror 63 are controlled to reflect the infrared radiation 4 into the reference channel 20 and then direct the infrared radiation 4 into the detector 3.

FIGS. 1G, 1H, and 1I are schematic diagrams showing NDIR detection apparatuses according to some embodiments of the present invention. In the illustrated embodiments, the reference channel 20 and the measurement channel 21 each have one detector. A first detector 3a receives the infrared radiation 4 transmitted through the reference channel 20, and a second detector 3b receives the infrared radiation 4 transmitted through the measurement channel 21. The infrared radiation 4 is imported into both the reference channel 20 and the measurement channel 21. Referring to FIG. 1G, the reference channel 20 and the measuring channel 21 have the same length. Referring to FIG. 1H, the reference channel 20 is located within the measurement channel 21 and has a shorter length than the measuring channel 21. Referring to FIG. 1I, the reference channel 20 is perpendicular to the measurement channel 21 and has a shorter length than the measuring channel 21. In addition, a front spectroscope 53 directs the infrared radiation 4 to the first detector 3a and the second detector 3b.

FIG. 2 is a block diagram of the NDIR detection apparatus depicted in FIG. 1G according to an embodiment of the present invention. Referring to FIG. 2, the signal processing circuit 7 (FIG. 3) may include an amplification circuit 70, an A/D conversion circuit 71, and a processor 72. The amplification circuit 70 amplifies the strength of the reference signal and the measurement signal from the first detector 3a and the second detector 3b. The A/D conversion circuit 71, consisting of reference and measurement A/D conversion circuits, converts an analog reference signal and an analog measurement signal, which have been subjected to signal strength amplification in the amplification circuit 70, into a digital reference signal and a digital measurement signal. In addition, a driving circuit for performing lighting control of the infrared light source 1 includes a light source driving circuit 80, a synchronous circuit 81, and a modulation circuit 82. The light source driving circuit 80 is designed to provide the necessary electrical power to the infrared light source 1 to emit infrared radiation 4. The modulation circuit 82 is to modulate the frequency of the infrared radiation 4, which involves changing the rate at which infrared light oscillates, and thus to lower the power consumption. In addition, the light source driving circuit 80 and the amplification circuit 70 are synchronized by the synchronous circuit 81. The circuits described above may be applied to other NDIR detection apparatuses described in this invention.

The concentration of the target component is determined based on equation (1), Beer-Lambert's law: I=I₀*e^(−acL). This law shows that there is an exponential relationship between the intensity of transmitted light (I) and the intensity of incident light (I₀), the absorption coefficient of the target component (a), the concentration of the target component (c), and the optical path length (L).

An initial infrared radiation intensity (I₀′) incident to the reference channel 20 and the measurement channel 21 is measured in advance at the time of manufacture of the NDIR detection apparatus before a fluid sample (e.g., a gas sample) is introduced. The initial infrared radiation intensity (I₀′), represented by initial reference signal, is stored in a memory of the signal processing circuit 7. A real-time infrared radiation intensity (I₀″), represented by the reference signal, is obtained at the time of measuring the concentration of target component.

In equation (1), the intensity of transmitted infrared radiation (I) from the measurement channel, represented by the measurement signal, is obtained at the time of measuring the concentration of the target component. And the intensity of incident light (I₀), is estimated by, for example, the difference between the real-time infrared radiation intensity (I₀″) and the initial infrared radiation intensity (I₀′).

The processor 72 is configured to perform this comparative analysis and compensation in a variety of ways. For example, the intensity of incident light (I₀) can be corrected based on drift. In one embodiment, this drift is calculated as an offset, determined by the difference between the real-time reference signal representing I₀″ and the initial reference signal representing I₀′. In another embodiment, the processor 72 determines a drift correction factor. This factor may be a multiplicative value, such as the ratio of the real-time reference signal to the initial reference signal (I₀″/I₀′). The processor 72 then applies this drift correction factor to the measurement signal to yield a corrected signal that compensates for system drift. In yet another embodiment, the processor 72 may utilize a pre-programmed lookup table or a polynomial function stored in the memory, which maps the measured real-time reference signal to a corresponding drift correction factor, thereby accounting for any non-linear effects of component aging or temperature.

FIG. 3 is a front view showing an NDIR detection apparatus according to an embodiment of the present invention. Referring to FIG. 3, an integrated cylinder-shaped optical cell 2 is divided into a reference channel 20 and a measurement channel 21, and the reference channel 20 and the measurement channel 21 may be separated and sealed by partition 213 with high infrared transmittance.

Although specific embodiments have been illustrated and described, it will be appreciated by those skilled in the art that various modifications may be made without departing from the scope of the present invention, which is intended to be limited solely by the appended claims.

What is claimed is:

1. A self-calibrating non-dispersive infrared (NDIR) detection apparatus, comprising:
an infrared light source emitting an infrared radiation at a specific wavelength corresponding to an absorption band of a target component in a fluid sample, wherein the specific wavelength is in a mid-and long-wavelength infrared region;
an optical cell comprising a reference channel and a measurement channel, wherein the infrared light source radiates the infrared radiation into the reference channel and the measurement channel, the reference channel is hermetically sealed and is vacuumed or contains a reference medium that does not absorb the infrared radiation at the specific wavelength, and the measurement channel is configured to flow the fluid sample;
at least one detector converting the infrared radiation that has transmitted through the reference channel into a reference signal and converting the infrared radiation that has transmitted through the measurement channel into a measurement signal;
a processor that calculates a concentration of the target component based on a comparative analysis of the reference signal and the measurement signal.

2. The NDIR detection apparatus according to claim 1, wherein the reference channel is sufficiently vacuumed such that an amount of the infrared radiation absorbed at the specific wavelength by medium enclosed in the reference channel is ignored.

3. The NDIR detection apparatus according to claim 1, wherein the reference medium is an inert gas comprising nitrogen, and a pressure of the reference channel is about 1 atmosphere.

4. The NDIR detection apparatus according to claim 1, wherein the infrared light source is an infrared thermal emitter that is wavelength-tunable to emit the infrared radiation with one or more specific wavelengths corresponding to one or more absorption bands of one or more target components, and wherein the one or more specific wavelengths are within the mid-and long-wavelength infrared region.

5. The NDIR detection apparatus according to claim 1, wherein the infrared radiation is narrowband.

6. The NDIR detection apparatus according to claim 1, wherein the at least one detector comprises a first detector, and the NDIR detection apparatus further comprises:
a front guiding unit disposed between the infrared light source and the optical cell and configured to modulate frequencies of the reference signal and the measurement signal or sequentially direct the infrared radiation into the reference channel and the measurement channel, so that the reference signal and the measurement signal are distinguishable or separable in the first detector.

7. The NDIR detection apparatus according to claim 6, wherein the front guiding unit comprises:
a first chopper between the infrared light source and the reference channel to periodically interrupt the infrared radiation at a first chopping interval; and
a second chopper between the infrared light source and the measurement channel to periodically interrupt the infrared light at a second chopping interval;
wherein the first chopping interval differs from the second chopping interval.

8. The NDIR detection apparatus according to claim 7, further comprising:
a rear guiding unit disposed between the optical cell and the first detector and configured to guide the infrared radiation to the first detector.

9. The NDIR detection apparatus according to claim 6, wherein the front guiding unit comprises a front reflecting mirror and a rotatable front handoff mirror to sequentially direct the infrared radiation into the reference channel and the measurement channel.

10. The NDIR detection apparatus according to claim 9, further comprising:
a rear guiding unit disposed between the optical cell and the first detector and configured to guide the infrared radiation to the first detector, wherein the rear guiding unit comprises a rear spectroscope and a rear reflecting mirror.

11. The NDIR detection apparatus according to claim 9, further comprising:
a rear guiding unit disposed between the optical cell and the first detector and configured to guide the infrared radiation to the first detector, wherein the rear guiding unit comprises a rotatable rear handoff mirror and a rear reflecting mirror.

12. The NDIR detection apparatus according to claim 1, wherein the at least one detector comprises a first detector to detect the infrared radiation from the reference channel and a second detector to detect the infrared radiation from the measurement channel.

13. The NDIR detection apparatus according to claim 12, wherein the reference channel is within the measurement channel and a length of the reference channel is shorter than a length of the measuring channel.

14. The NDIR detection apparatus according to claim 12, wherein the reference channel is perpendicular to the measurement channel and a length of the reference channel is shorter than a length of the measuring channel.

15. The NDIR detection apparatus according to claim 1, further comprising:
a memory storing an initial reference signal, the initial reference signal representing an intensity of the infrared radiation transmitted through the reference channel at a time of manufacture;
wherein the processor is configured to: (i) determine a drift correction factor based on a comparison of the real-time reference signal with the stored initial reference signal, and (ii) calculate the concentration of the target component by applying the drift correction factor to the measurement signal to compensate for drift of the NDIR detection apparatus.

16. The NDIR detection apparatus according to claim 1, wherein the optical cell is cylinder-shaped and plated with gold or a highly reflective material to effectively guide the infrared radiation through the reference channel and the measurement channel by multiple reflections.

17. The NDIR detection apparatus according to claim 16, wherein the cylinder-shaped optical cell is integrated and divided into the reference channel and the measurement channel.

18. A method for self-calibrating a non-dispersive infrared (NDIR) detection apparatus, comprising:
(a) directing an infrared radiation with a specific wavelength emitted from an infrared light source, wherein the specific wavelength corresponds to an absorption band of a target component and is in a mid-and long-wavelength infrared region;
(b) splitting the infrared radiation into a measurement path configured to receive a fluid sample containing the target component, and splitting the infrared radiation into a reference path that is hermetically sealed and is vacuumed or contains a reference medium that does not absorb the infrared radiation at the specific wavelength;
(c) converting the infrared radiation that penetrates the measurement path with at least one detector to generate a measurement signal;
(d) converting the infrared radiation that penetrates the reference path with the at least one detector to generate a reference signal; and
(e) by a processor, calculating a concentration of the target component by correcting the measurement signal to compensate for drift in the NDIR detection apparatus, wherein the drift is determined based on a comparison of the real-time reference signal, generated in step (d), to a pre-established baseline reference signal.
